(19) United States
(12) Patent Application Publication
(10) Pub. No.: US 2025/0365634 A1
(43) Pub. Date: Nov. 27, 2025

(54) COMMUNICATION CONTROL METHOD, NETWORK NODE AND USER EQUIPMENT

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/292,170

(22) Filed: Aug. 6, 2025

Related U.S. Application Data
(63) Continuation of application No. PCT/JP2024/003755, filed on Feb. 5, 2024.

(30) Foreign Application Priority Data
Feb. 7, 2023 (JP) 2023-017192

(51) Int. Cl. H04W 36/36; H04W 36/30

(52) U.S. Cl. CPC H04W 36/362; H04W 36/30

(57) ABSTRACT

The present disclosure relates to a communication control method in a mobile communication system. The communication control method includes configuring, by a base station, a predetermined range of radio quality for a user equipment. Here, the predetermined range of radio quality represents a range of radio quality in which the user equipment is allowed to determine an execution timing of a conditional handover using an AI/ML model.

### RELATED APPLICATIONS

The present application is a continuation based on PCT Application No. PCT/JP2024/003755, filed on Feb. 5, 2024, which claims the benefit of Japanese Patent Application No. 2023-017192 filed on Feb. 7, 2023. The content of which is incorporated by reference herein in their entirety.

### TECHNICAL FIELD

The present disclosure relates to a communication control method, network node and user equipment.

### BACKGROUND

In recent years, in the Third Generation Partnership Project (3GPP) (trade name), which is a standardization project for mobile communication systems, a study has been underway to apply an Artificial Intelligence (AI) technology, particularly, a Machine Learning (ML) technology to wireless communication (air interface) in the mobile communication system.

For example, Non-Patent Document 1 listed below discusses AI-based mobility management. That is, Non-Patent Document 1 states that mobility characteristics may be degraded for reasons such as increased density of network deployment due to increased frequency and that as a result of simulation of AI inference for mobility failures including a handover command loss and a handover failure (HOF), high accuracy has been successfully achieved for the mobility failures. Non-Patent Document 2 listed below also states that with regard to mobility management, generalization of a model needs to be studied from a viewpoint of high-speed movement.

### CITATION LIST

### Non-Patent Literature

Non-Patent Document 1: 3GPP contribution document: RP-223079, “Study on AI/ML for NR air interface higher layer”
Non-Patent Document 2: 3GPP contribution document: RP-222954, “Motivation on AI/ML for NR air interface high layer”

### SUMMARY

In an aspect, a communication control method is a communication control method in a mobile communication system. The communication control method includes configuring, by a network node, a predetermined range of radio quality for a user equipment. Here, the predetermined range of radio quality represents a range of radio quality in which the user equipment is permitted to determine an execution timing of a conditional handover using an AI/ML model.

In an aspect, a communication control method is a communication control method in a mobile communication system. The communication control method includes transmitting, by a user equipment to a network node, log information including an execution result of a handover and execution trigger information indicating one of the handover having been executed using an AI/ML model or the handover having been executed using a network configuration without using the AI/ML model.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an example of reducing CSI-RSs according to the first embodiment.

FIG. 10 is a diagram illustrating an example of reducing the CSI-RSs according to the first embodiment.

FIG. 11 is a diagram illustrating an example of an operation according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an arrangement example of functional blocks of the AI/ML technology according to the first embodiment.

FIG. 15 is a diagram illustrating an operation example according to the first embodiment.

FIG. 16 is a diagram illustrating an arrangement example of functional blocks of the AI/ML technology according to the first embodiment.

FIG. 17 is a diagram illustrating an operation example according to the first embodiment.

FIG. 18 is a diagram illustrating an operation example according to the first embodiment.

FIG. 19 is a diagram illustrating an example of a configuration message according to the first embodiment.

FIG. 20 is a diagram illustrating an operation example according to the first embodiment.

FIG. 21 is a diagram illustrating an operation example according to the second embodiment.

### DESCRIPTION OF EMBODIMENTS

An object of the present disclosure is to enable a user equipment to appropriately execute wireless communication using an AI/ML model.

### First Embodiment

A mobile communication system according to a first embodiment will be described with reference to the drawings. In the description of the drawings, the same or similar parts are denoted by the same or similar reference signs.

### Configuration of Mobile Communication System

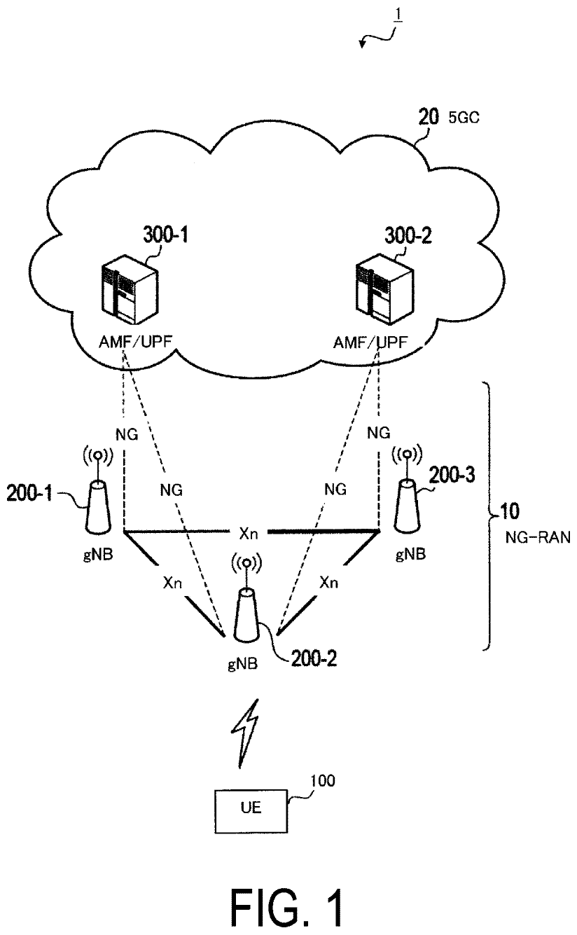

A configuration of a mobile communication system according to a first embodiment will be described. FIG. 1 is a diagram illustrating a configuration example of the mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

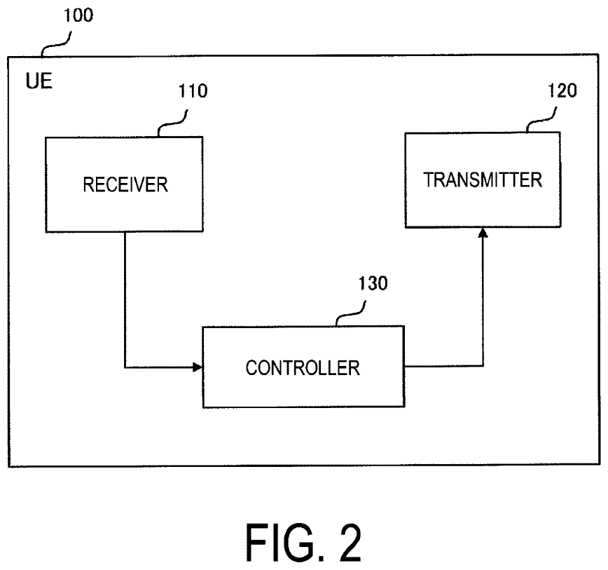

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

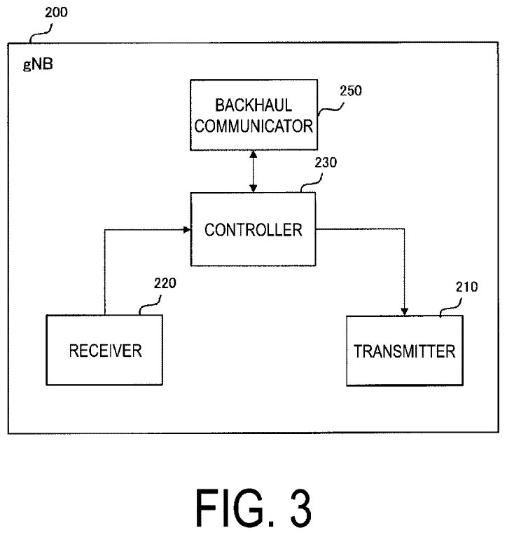

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

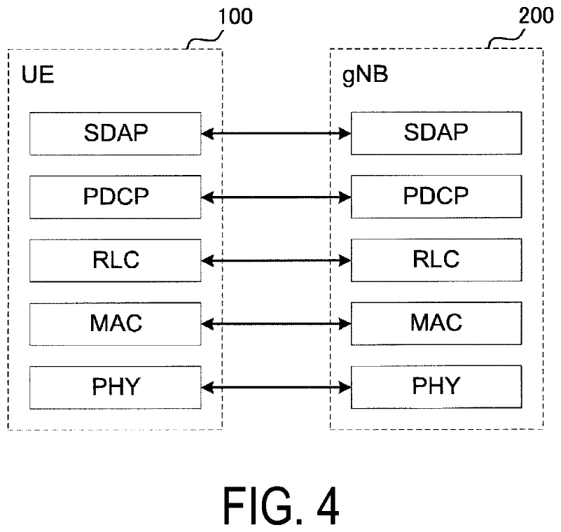

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. A Cyclic Redundancy Code (CRC) parity bit scrambled by the RNTI is added to the DCI transmitted from the gNB 200.

In NR, the UE 100 can use a bandwidth narrower than a system bandwidth (i.e., a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

A MAC layer performs priority control of data, retransmission processing through Hybrid Automatic Repeat reQuest (HARQ: Hybrid ARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception end by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QOS) control by the core network, and radio bearers, which are units for QoS control by the Access Stratum (AS). Note that, when the RAN is connected to the EPC, the SDAP need not be provided.

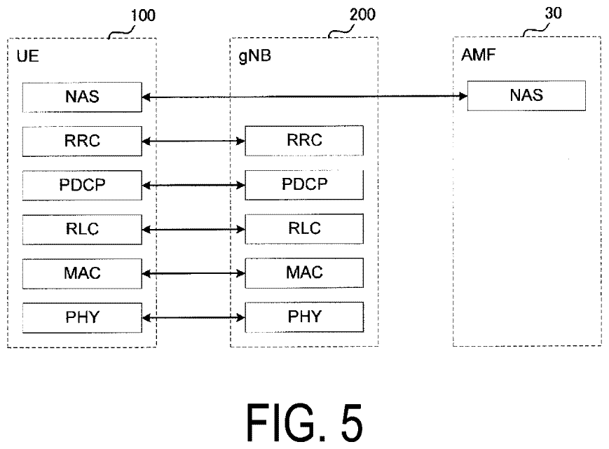

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### AI/ML Technology

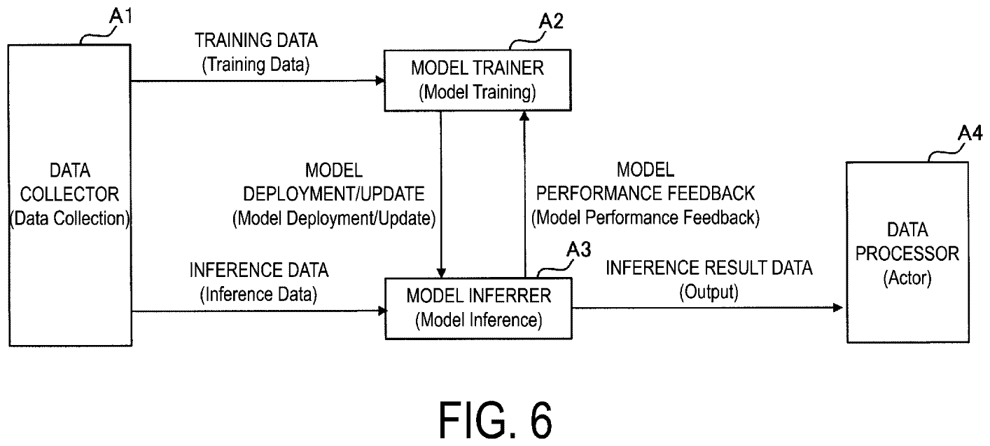

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus.

The model trainer A2 performs model training. Specifically, the model trainer A2 optimizes parameters of the training model through machine learning using the training data, and derives (or deploys, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although supervised learning will be described below, unsupervised learning or reinforcement learning may be applied as machine learning.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2.

The data processor A4 receives the inference result data and performs processing that utilizes the inference result data.

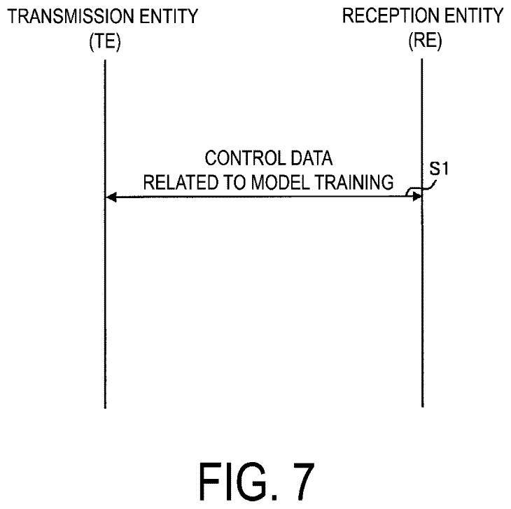

FIG. 7 is a diagram illustrating an operation example in the AI/ML technology according to the first embodiment.

A transmission entity TE is, for example, an entity in which machine learning is performed. The transmission entity TE derives a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The transmission entity TE performs various processing operations by using the inference result data received from the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE 100.

As illustrated in FIG. 7, in a step S1, the transmission entity TE transmits to and receives from the reception entity RE control data related to the AI/ML technique. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (e.g., an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”
   Hereinafter, an arrangement example of the functional blocks will be described for each use case.

### (1.1) Arrangement Example of Functional Blocks in “CSI Feedback Enhancement”

The “CSI feedback enhancement” represents, for example, a use case where the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

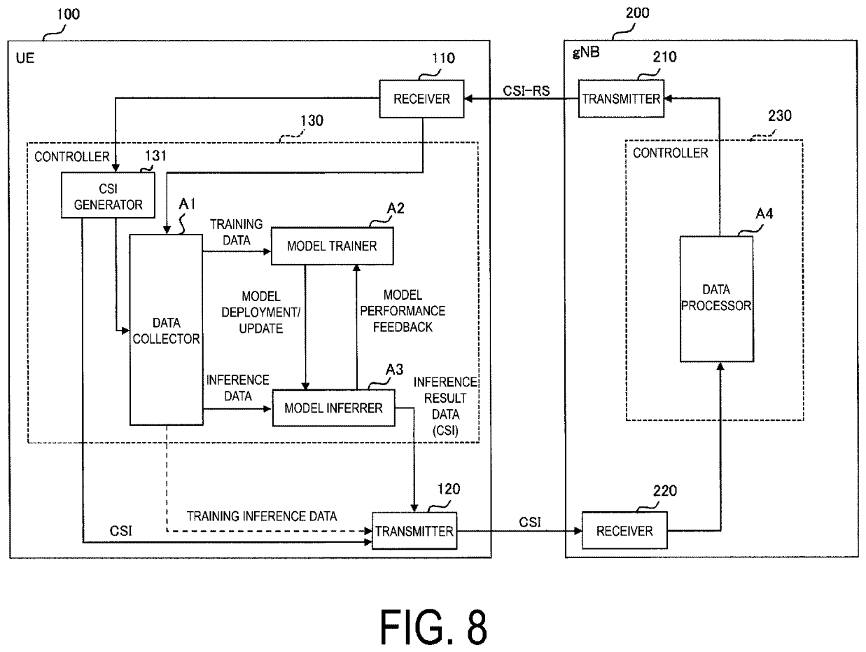

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal and the CSI. Such a first reference signal may be referred to as a full CSI-RS.

For example, the CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

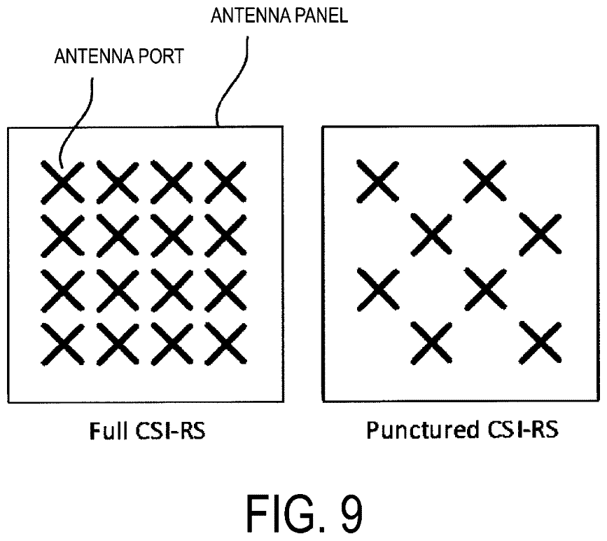

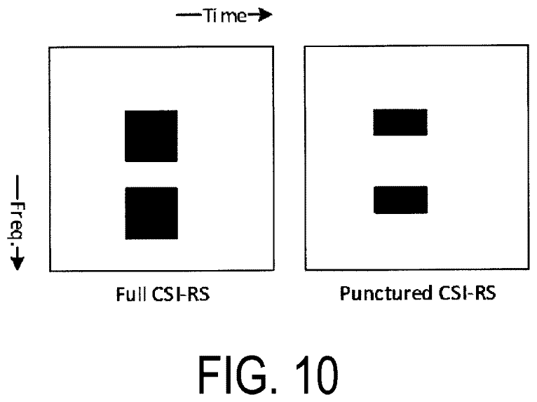

FIGS. 9 and 10 are diagrams illustrating an example of reducing CSI-RSs according to the first embodiment.

FIG. 9 illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 10 illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9 and 10, the gNB 200 transmits the full CSI-RS using a predetermined amount of first resources, and transmits the partial CSI-RS using second resources that are less than the first resources.

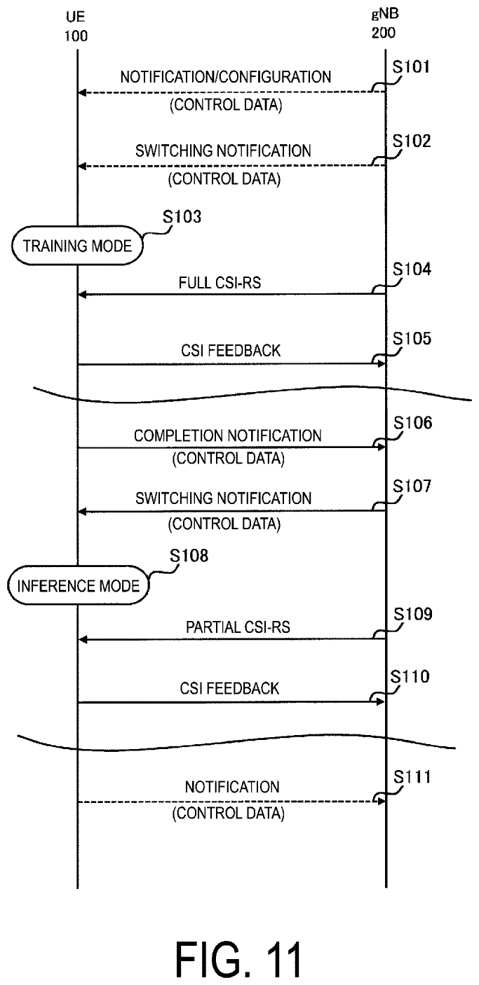

FIG. 11 illustrates an operation example in the “CSI feedback enhancement” according to the first embodiment.

As illustrated in FIG. 11, in step S101, the gNB 200 may notify the UE 100 of or configure for the UE, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching information notification for switching from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back) the CSI, which is an inference result, to the gNB 200 as inference result data. The UE 100 can deploy a trained model with a predetermined accuracy or higher by repeating model training in the training mode. The inference result obtained by using the trained model deployed as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 11, the training data is “(full) CSI-RS” and “CSI”, and the inference data is “(partial) CSI-RS”. Hereinafter, the training data and/or the inference data may be referred to as a “dataset”.

In the “CSI feedback enhancement”, for example, at least one selected from the group consisting of the following data and/or information may be used as the dataset in addition to the “CSI-RS” and the “CSI”.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits the data type information used as a dataset, to the UE 100 as the control data. The data type information may represent, for example, any one of data or information indicated in (X1) to (X3). As the data type information, data type information used as training data and data type information used as inference data may be separately designated.

### (1.2) Arrangement Example of Functional Blocks in “Beam Management”

An arrangement example of the functional blocks in the “beam management” will be described. The “beam management” represents, for example, a use case where the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

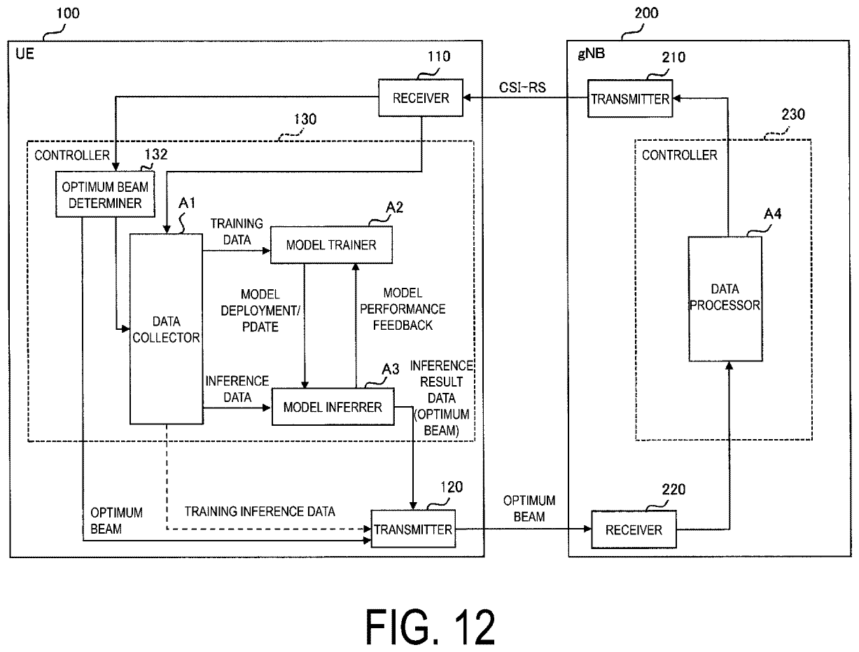

FIG. 12 is a diagram illustrating an arrangement example of the functional blocks in the “beam management”. In the example of the “beam management” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 perform model training and model inference. FIG. 12 illustrates the example in which the transmission entity TE is the UE 100 and the reception entity RE is the gNB 200.

As illustrated in FIG. 12, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 11.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, at least one selected from the group consisting of the following data or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER ((BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)
   The UE 100 may transmit capability information as the control data to the gNB 200, the capability information indicating which type of input data the UE 100 can handle in the machine learning. The capability information may include any information or data from among (Y1) to (Y6), or may include, aside from the training data and the inference data, any information or data from among (Y1) to (Y6). The gNB 200 may transmit the data type information used as a dataset, to the UE 100 as the control data. The data type information may include any information or data from among (Y1) to (Y6), or may include, aside from the training data and the inference data, the data type information may include any information or data from among (Y1) to (Y6), for example.

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case where the accuracy of the position information measured by the UE 100 is enhanced using the machine learning technology.

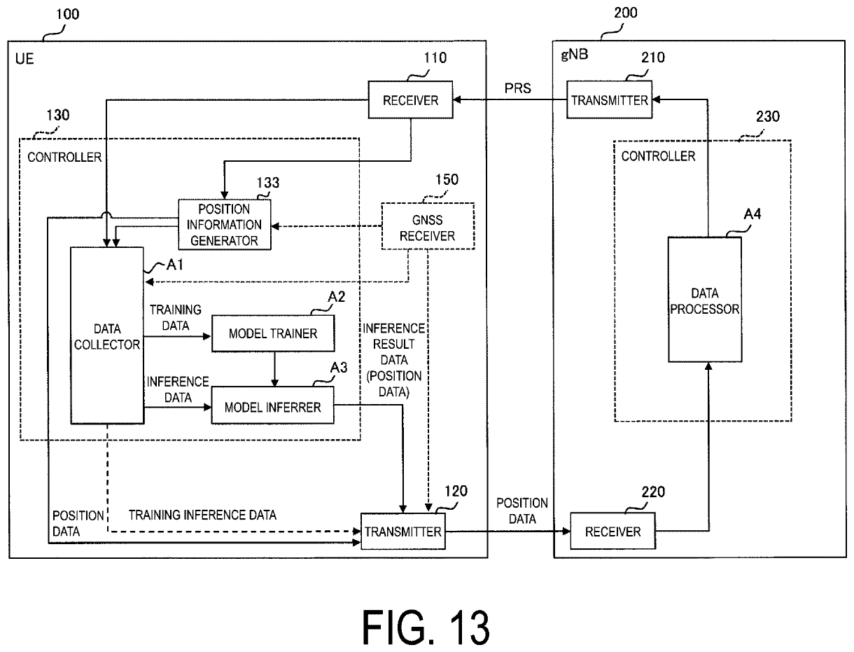

FIG. 13 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model trainer A2, and the model inferrer A3. On the other hand, the controller 230 of the gNB 200 includes the data processor A4. In other words, FIG. 13 illustrates an example in which the UE 100 performs model training and model inference. FIG. 13 illustrates an example in which the transmission entity TE is the UE 100 and the reception entity RE is the gNB 200.

As illustrated in FIG. 13, the UE 100 includes a position information generator 133. The UE 100 may include a Global Navigation Satellite System (GNSS) reception device 150. The position information generator 133 generates position data of the UE 100 based on a Positioning Reference Signal (PRS) (full PRS or partial PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports as illustrated in FIG. 9 or a predetermined amount of time frequency resources as illustrated in FIG. 10). Similarly to the partial CSI-RS, the gNB 200 transmits the partial PRS using second resources the amount of which is smaller than that of the first resources (g for example, half of the antenna ports in the antenna panel as illustrated in the ninth, or half of the predetermined amount of time frequency resources as shown in FIG. 10).

The full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “position accuracy improvement” can be implemented by replacing the “full CSI-RS” with the “full PRS”, the “partial CSI-RS” with the “partial PRS”, and the “CSI feedback” with the “position data” in FIG. 11.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, at least one selected from the group consisting of the following data or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless Local Area Network (LAN) such as Wi-Fi (trade name), or Bluetooth (trade name)
(Z7) Moving speed of the UE 100 (the moving speed may be measured by the GNSS reception device 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to
(Z7). Aside from the training data and the inference data, the capability information may include any information or data from among (Z1) to (Z7). The gNB 200 may transmit the data type information used as a dataset, to the UE 100 as the control data. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

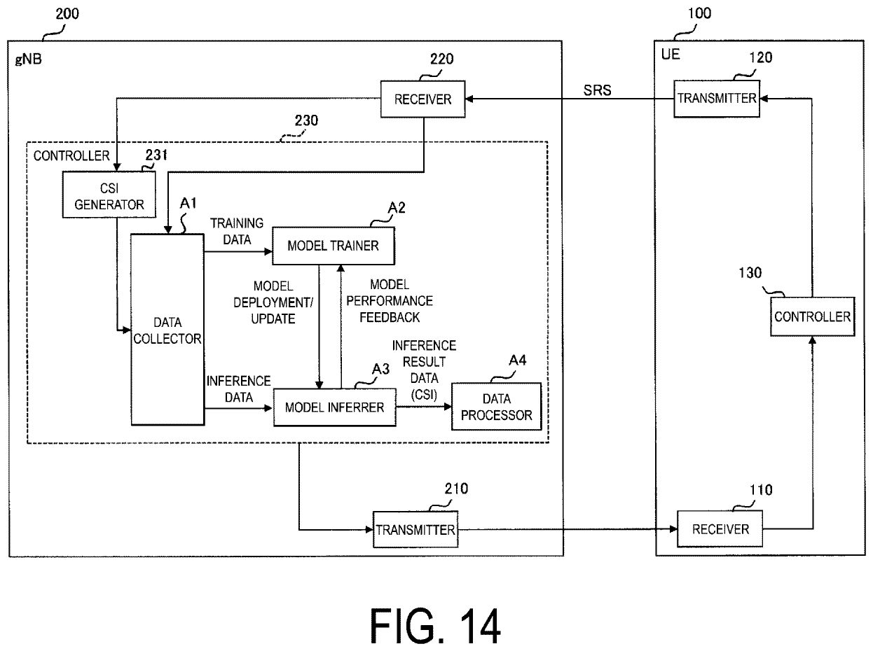

FIG. 14 is a diagram illustrating another arrangement example of the “CSI feedback enhancement” according to the first embodiment. FIG. 14 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 14 illustrates an example in which the transmission entity TE is the gNB 200 and the reception entity RE is the UE 100.

FIG. 14 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (e.g., the data processor A4) performs, for example, uplink scheduling based on the CSI generated based on the SRS.

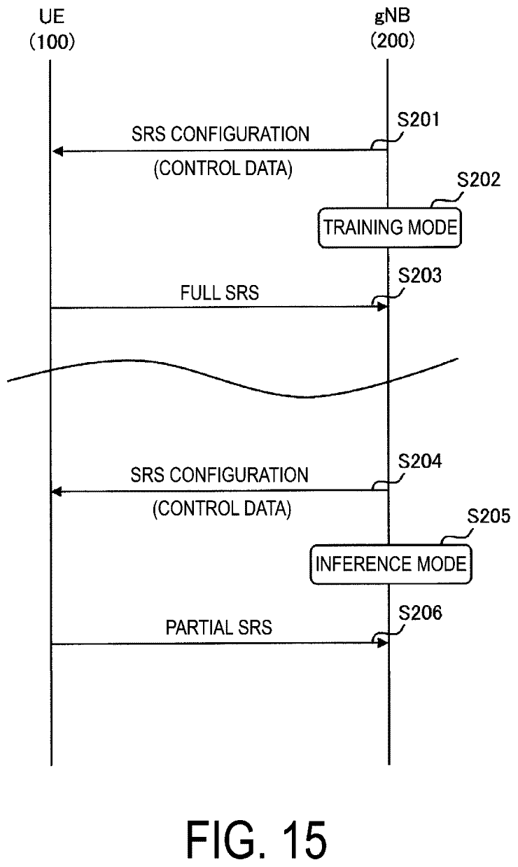

FIG. 15 is a diagram illustrating an operation example in another arrangement example according to the first embodiment.

As illustrated in FIG. 15, in step S201, the gNB 200 provides SRS configuration for the UE 100. The SRS transmission configuration may include type information of the reference signal transmitted by the UE 100.

In step S202, the gNB 200 starts the training mode.

In step S203, the UE 100 transmits a full SRS to the gNB 200 in accordance with the SRS transmission configuration (step S201). The receiver 220 of the gNB 200 receives the full SRS. In the training mode, the CSI generator 231 generates (or estimates) CSI based on the full SRS. The data collector A1 collects the full SRS and the CSI. The model trainer A2 uses the full SRS and the CSI as training data to generate a trained model.

In step S204, the gNB 200 specifies the transmission pattern (puncture pattern) of the SRS to be input to the trained model as the inference data, and configures the specified SRS transmission pattern for the UE 100. The gNB 200 may transmit, to the gNB 200, the SRS transmission configuration including the specified SRS transmission pattern.

In step S205, the gNB 200 switches from the training mode to the inference mode. The gNB 200 starts the model inference using the trained model.

In step S206, the UE 100 transmits the partial SRS in accordance with the SRS transmission configuration (step S204). When the gNB 200 inputs the SRS as the inference data to the trained model to obtain a channel estimation result, the gNB 200 performs uplink scheduling (e.g., control of uplink transmission weights and the like) of the UE 100 by using the channel estimation result. Note that when the inference accuracy achieved by the trained model deteriorates, the gNB 200 may reconfigure the UE 100 to cause the UE 100 to transmit the full SRS.

### (1.5) Arrangement Example when Federated Learning is Performed

An arrangement example of the functional blocks used when federated learning is performed will be described. The federated learning is, for example, one approach for machine learning in which machine learning is performed in a state where data (or a dataset) is not aggregated but distributed. In the federated learning, each entity does not need to transmit data, and thus the security of the entity can be ensured. The federated learning is considered to be able to obtain a training result with accuracy equivalent to that of the conventional centralized machine learning.

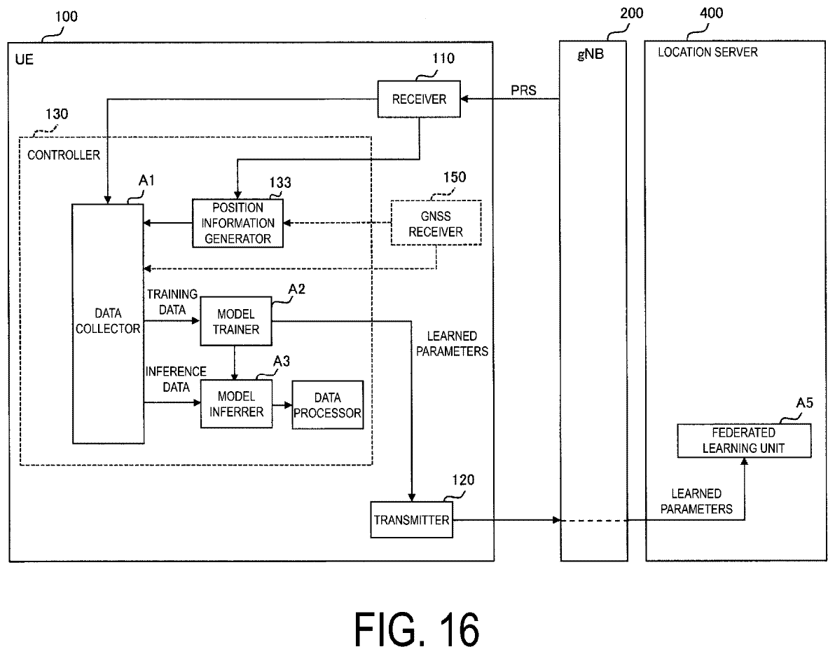

FIG. 16 is a diagram illustrating an arrangement example in which the federated learning according to the first embodiment is performed. The example illustrated in FIG. 16 illustrates an example of a case in which the position estimation of the UE 100 is performed using the federated learning. FIG. 16 illustrates an example in which the UE 100 includes the data collector A1, the model trainer A2, and the model inferrer A3. In other words, FIG. 16 illustrates an example in which the UE 100 performs model training and model inference. FIG. 16 illustrates an example in which the UE 100 is the transmission entity TE and the gNB 200 and/or a location server 400 is the reception entity RE.

The federated learning illustrated in FIG. 16 is performed in the following procedure, for example.

First, the location server 400 transmits, to the UE 100, the model on which model training is based.

Second, the UE 100 (model trainer A2) performs model training using the data present in the UE 100. The data present in the UE 100 may be, for example, a PRS received from the gNB 200 and/or output data (GNSS signal) from the GNSS reception device 150. The data present in the UE 100 may include position data generated by the position information generator 133 based on the reception result of the PRS and/or the output data from the GNSS reception device 150.

Third, the UE 100 applies the trained model, which is the training result, to the model inferrer A3 and transmits, to the location server 400, variable parameters included in the trained model (hereinafter also referred to as “learned parameters”). In the above example, the optimized a (slope) and b (intercept) correspond to the learned parameters.

Fourth, the location server 400 (federated learning unit A5) collects the learned parameters from a plurality of UEs 100 and integrates these parameters. The location server 400 may transmit, to the UE 100, the trained model obtained by the integration. The location server 400 can estimate the position of the UE 100 based on the trained model and a measurement report from the UE 100.

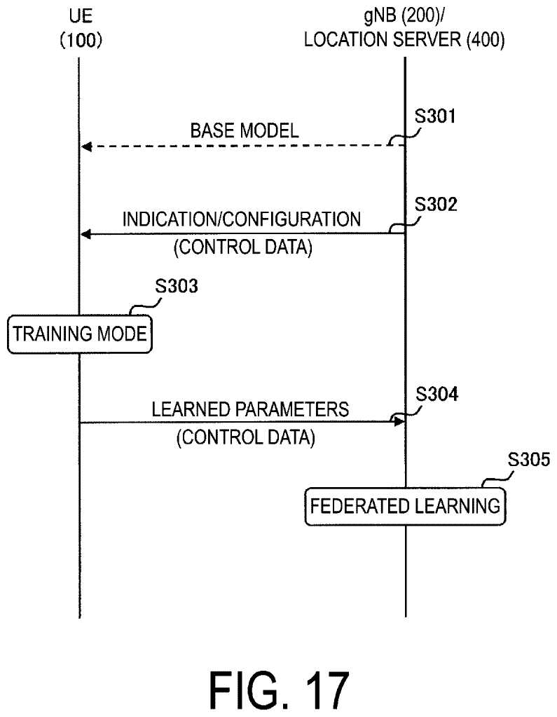

FIG. 17 is a diagram illustrating an operation example in the federated learning according to the first embodiment.

As illustrated in FIG. 17, in step S301, the gNB 200 may notify the UE 100 of a model on which learning of the UE 100 is based. The location server 400 may notify the UE of the model via the gNB 200.

In step S302, the gNB 200 indicates the UE 100 about model training. The gNB 200 may configure a report timing (trigger condition) of the learned parameters. The report timing may be a periodic timing. The report timing may be a timing triggered by learning proficiency satisfying a condition (i.e., an event trigger).

In step S303, the UE 100 starts the training mode. The UE 100 performs model training using, as the training data, the full PRS (or the full GNSS signal) and the position data generated by the position information generator 133.

In step S304, when the condition of the report timing is satisfied, the UE 100 transmits, to the network (gNB 200 or location server 400) the learned parameters obtained at that time.

In step S305, the location server 400 integrates the learned parameters reported from a plurality of UEs 100.

### (1.6) Model Transfer Example

In (1.1) to (1.5), the arrangement example of the functional blocks of the AI/ML technology has been described. A model transfer example will be described below. The model to be transferred may be a trained model used in the model inference. The model may be an untrained model used in the model training (or a model being trained).

### (1.6.1) First Operation Pattern Relating to Model Transfer

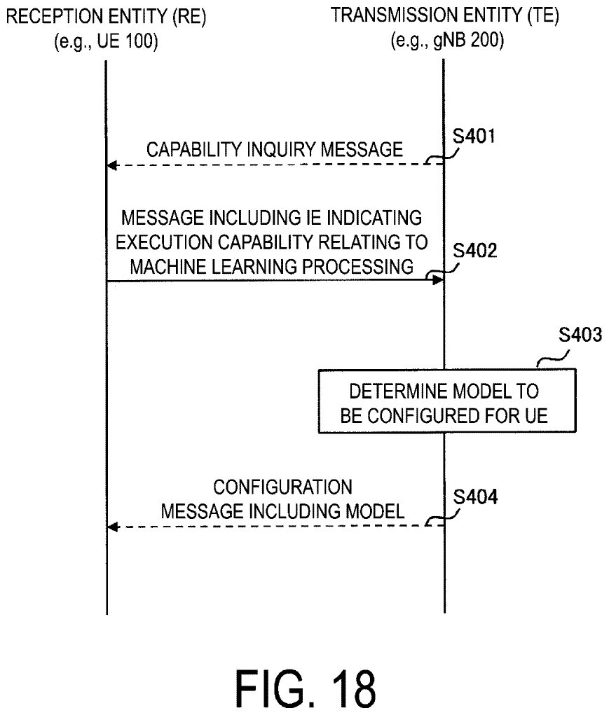

FIG. 18 is a diagram illustrating an operation example of a first operation pattern relating to model transfer according to the first embodiment. In the example illustrated in FIG. 18, the reception entity RE is mainly described as the UE 100. However, the reception entity RE may be the gNB 200 or AMF 300. In the example illustrated in FIG. 18, the transmission entity TE is mainly described as the gNB 200. However, the transmission entity TE may be the UE 100 or AMF 300.

As illustrated in FIG. 18, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (e.g., a “UE AI Capability” message or the like). Alternatively, the transmission entity TE may be the AMF 300 and the message may be a NAS message. When a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may indicate the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may indicate the processing capacity of the learning processing.

In step S403, the gNB 200 determines a model to be configured (deployed) for the UE 100 based on the information element included in the message received in step S402.

In step S404, the gNB 200 transmits, to the UE 100, a message including the model determined in step S403. The UE 100 receives the message and performs the machine learning processing (i.e., model learning processing and/or model inference processing) using the model included in the message. A specific example of step S404 will be described in a second operation pattern below.

### (1.6.2) Second Operation Pattern Relating to Model Transfer

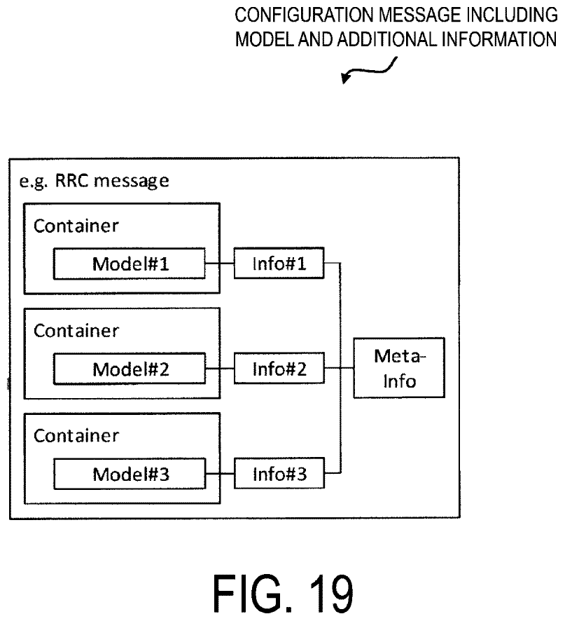

FIG. 19 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like). Alternatively, the configuration message may be a NAS message transmitted from the AMF 300 to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

### (1.7) Communication Control Method According to First Embodiment

A communication control method according to the first embodiment will be described.

As described above, regarding AI-based mobility management, Non-Patent Document 1 states that high accuracy has been successfully achieved as a result of simulation of AI inference for mobility failures including a handover command loss and a handover failure. However, Non-Patent Document 1 does not discuss how the AI/ML model has specifically been deployed to obtain the simulation result. Non-Patent Document 2 neither discusses specific deployment of an AI/ML model.

Here, for mobility management, handover will be considered. When the AI/ML model exists on the UE 100 side, in a normal handover, the gNB 200 makes a handover decision. This leads to very minor involvement of the AI/ML model compared to the case where the AI/ML model exists on the gNB 200 side.

On the other hand, for the handover, a conditional handover will be considered. In this case, the UE 100 side determines a trigger condition for the conditional handover and the like, and thus when the AI/ML model exists on the UE 100 side, the possibility that the AI/ML model can be involved is higher than when the AI/ML model exists on the gNB 200 side.

However, the trigger condition for the conditional handover is well defined. Thus, even when the AI/ML model exists on the UE 100 side, that the UE 100 has little room for determination by itself.

On the other hand, when the UE 100 side is allowed to make all the determinations for the conditional handover, this may not necessarily be appropriate from the viewpoint of network control.

Thus, an object of the first embodiment is to enable (the AI/ML model of) the UE 100 is appropriately determine the timing of the conditional handover with the network control preserved. Another object of the first embodiment is to allow the UE 100 to appropriately execute wireless communication using the AI/ML model by allowing the UE 100 to appropriately determine the timing of the conditional handover.

Thus, in the first embodiment, the gNB 200 configures the UE 100 with a range of radio quality in which the UE 100 may determine the execution timing of the conditional handover using the AI/ML model.

Specifically, the base station (for example, the gNB 200) configures a predetermined range of radio quality for the user equipment (for example, the UE 100). Here, the predetermined range of radio quality represents a range of radio quality in which the user equipment is permitted to determine the execution timing of the conditional handover using the AI/ML model.

In this way, the UE 100 can determine the execution timing of the conditional handover using the AI/ML model in the predetermined range of the radio qualities, and therefore the UE 100 can appropriately determine the execution timing of the conditional handover. Moreover, the gNB 200 determines and transmits the predetermined range of wireless communication to the UE 100, and thus the UE 100 can appropriately determine the timing of the conditional handover while preserving the network control. Accordingly, the UE 100 can appropriately execute wireless communication by using the AI/ML model.

### (1.8) Conditional Handover (CHO)

Here, the conditional handover according to the first embodiment will be described. The conditional handover is a handover executed by the UE 100 when one or more handover execution conditions are satisfied. The UE 100 starts evaluating the handover execution condition upon receiving a conditional reconfiguration (ConditionalReconfiguration) from the gNB 200. The handover execution condition includes one or two trigger conditions. The conditional configuration includes a candidate cell and a trigger condition. When at least one candidate cell satisfies the handover execution condition, the UE 100 leaves the source gNB and starts connecting to a selected candidate cell. Note that the conditional configuration is notified from the gNB 200 to the UE 100 by dedicated signaling (for example, an RRC reconfiguration (RRCReconfiguration) message).

In this way, unlike a normal handover (which may hereinafter be referred to as a “legacy handover”) in which the UE 100 reports a measurement value of a radio state to the gNB 200 and the gNB 200 determines a handover to a neighboring cell based on the report, the conditional handover can autonomously execute a handover to a candidate cell that satisfies the trigger condition.

### (1.9) Operation Example According to First Embodiment

An operation example according to the first embodiment will be described.

The AI/ML model used in the operation example according to the first embodiment exists in the UE 100 (“UE-side one-sided model”). An input to the AI/ML model is information related to the radio environment. Specifically, the input may be measurement information for a serving cell, a candidate cell, or the like. The input may be movement information indicated by a speed or a direction of the UE 100. Alternatively, the input may be position information of the UE 100. On the other hand, an output from the AI/ML model is an execution timing of the conditional handover (i.e., the timing of access to a target cell).

That is, the AI/ML model used in the operation example of the first embodiment is a model that receives, as an input, information related to the radio environment and the like and outputs the execution timing of the conditional handover.

Hereinafter, the “AI/ML model” and an “inference model” may be used without distinction. The inference model may be the “trained model”. An “input” to the inference model may be referred to as “inference data”, and an “output” from the inference model may be referred to as an inference result.

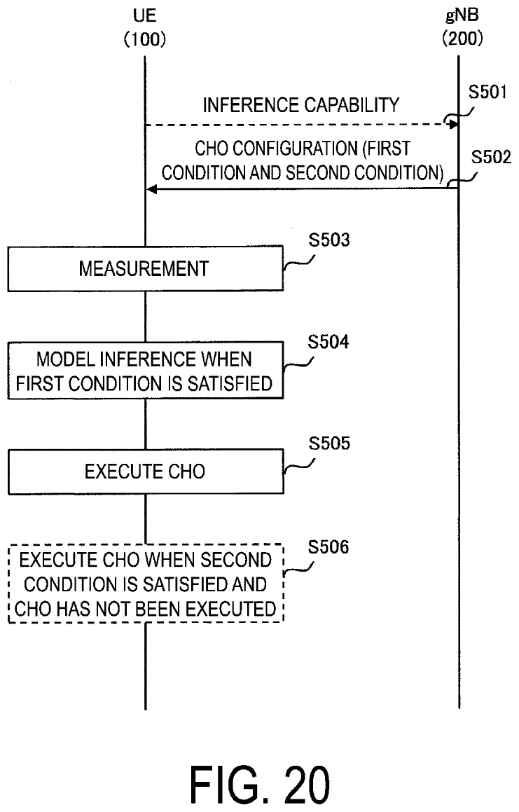

FIG. 20 is a diagram illustrating an operation example according to the first embodiment.

As illustrated in FIG. 20, in step S501, the UE 100 may notify the gNB 200 that the UE has the capability of determining (or inferring) the execution timing of the conditional handover. An RRC message (e.g., a UECapability message) may be used for the notification.

In step S502, the gNB 200 configures the conditional handover for the UE 100. To be more specific, the gNB 200 may configure the conditional handover using the above-described conditional reconfiguration (ConditionalReconfiguration).

First, the configuration of the conditional handover includes a range of radio quality in which the UE 100 is permitted to determine the conditional handover. The range of radio quality in which the UE 100 is permitted to determine the conditional handover may be referred to as a “predetermined range of radio quality”. The predetermined range of radio quality may represent a range of radio quality in which the UE 100 is permitted to determine the execution timing of the conditional handover using the AI/ML model. For example, the predetermined range of radio quality may be the RSRP of the serving cell ranging from “−80 dBm to −90 dBm” or the like. When the RSRP of the serving cell is within this range, the UE 100 can infer (or determine) the execution timing of the conditional handover using the AI/ML model. The radio quality is one of Reference Signal Received Power (RSRP), Reference Signal Received Quality (RSRQ), or Signal to Interference plus Noise Ratio (SINR)).

Specifically, the configuration of the conditional handover includes a first condition including the predetermined range of radio quality.

The first condition is, for example, as follows.

(X1) Indicates that when the configuration of the conditional handover includes event A2 (Serving becomes worse than threshold), the UE 100 is permitted to determine the execution timing of the conditional handover using the AI/ML model when the radio quality (the radio quality within the predetermined range) of the serving cell become worse than an event A2 threshold.

(X2) Indicates that when the configuration of the conditional handover includes event A3 (Neighbor becomes offset better than PCel), the UE 100 is permitted to determine the execution timing of the conditional handover using the AI/ML model when the radio quality (the radio quality within the predetermined range) of the neighboring cell is better than the radio quality (the radio quality within the predetermined range) of the serving cell plus an offset.

(X3) Indicates that when the configuration of the conditional handover includes event A4 (Neighbor becomes better than threshold), the UE 100 is permitted to determine the execution timing of the conditional handover using the AI/ML model when the radio quality (the radio quality within the predetermined range) of the neighboring cell is better than an event A3 threshold.

(X4) Indicates that when the configuration of the conditional handover includes event A5 (PCell becomes worse than threshold1 and neighbor becomes better than threshold2), the UE 100 is permitted to determine the execution timing of the conditional handover using the AI/ML model when the radio quality of the serving cell is worse than an event A5 first threshold and the radio quality of the neighboring cell is better than an event A5 second threshold.

The predetermined range of wireless communication may be a range in which the UE 100 is permitted to perform the conditional handover based on the model inference. This range may be used as the first condition. Specifically, the range may be indicated by an upper limit value and a lower limit value, for example. The range may be indicated only by the upper limit value. The range may be indicated only by the lower limit value. The range may be expressed as an offset with respect to a second condition described below.

Second, the configuration of the conditional handover may include a radio quality condition for performing the conditional handover regardless of which execution timing of the conditional handover the UE 100 determines. For example, when the AI/ML model does not determine the execution timing of the conditional handover for some reason, the radio quality condition is used to forcibly execute the conditional handover when the radio quality for the UE 100 is at a specific level. The radio quality condition is used, for example, as a relief measure when the UE 100 cannot determine the execution timing. The radio quality condition may be represented by a threshold of radio quality at which the UE 100 causes the conditional handover to be executed without using the AI/ML model. For example, the radio quality condition used may be, for example, that the UE 100 necessarily executes the conditional handover when the RSRP of the serving cell becomes “−90 dBm”. The radio quality condition may be the threshold of radio quality at which the UE 100 is caused to execute the conditional handover without using the AI/ML model.

This radio quality condition is included in a second condition. The second condition may be the same as a trigger condition (e.g., event A2 or event A5) of the existing conditional handover. The radio quality condition is, for example, a threshold included in the trigger condition.

In this way, the gNB 200 configures the UE 100 with the first condition for the conditional handover including the predetermined range of radio quality and the second condition for the conditional handover including the threshold of radio quality (that is, the radio quality condition).

In step S503, the UE 100 measures the radio quality of the serving cell and/or the neighboring cell.

In step S504, when the radio quality satisfies the first condition, UE 100 infers (or determines) the execution timing of the conditional handover using the AI/ML model.

In step S505, when the AI/ML model infers an appropriate execution timing, the UE 100 executes the conditional handover at the execution timing, and starts to access the target cell.

On the other hand, in step S506, when the AI/ML model fails to appropriately infer the execution timing, and the radio quality satisfies the second condition, UE 100 executes the conditional handover without using the AI/ML model. The UE 100 may stop the model inference performed by the AI/ML model.

### (1.10) Another Example According to First Embodiment

In the first embodiment, the permission of the execution timing provided by the AI/ML model for the range of radio quality has been described, but the present disclosure is not limited thereto. For example, not only the radio quality but also the distance or time may be used. An accepted range of distance or time may be configured, and the execution timing of the conditional handover provided by the AI/ML model may be permitted within the configured range. For example, the first condition may include two trigger conditions described below.

(X5) Conditional event D1 (CondEvent D1): When the conditional handover configuration includes conditional event D1, the UE 100 is permitted to determine the execution timing of the conditional handover using the AI/ML model when the distance between the UE 100 and a first reference position is larger than an event D1 first threshold and the distance between the UE 100 and a second reference position of a conditional reconfiguration candidate is smaller than an event D1 second UE 100 threshold.

(X6) Conditional Event T1 (CondEvent T1): When the conditional handover configuration includes conditional event T1, the UE 100 is permitted to determine the execution timing of the conditional handover using the AI/ML model when the time measured by the UE 100 is longer than the event T1 threshold and shorter than (event T1 threshold−predetermined threshold+duration).

For example, a range of distance in which the execution timing provided by the AI/ML model is permitted is configured for the distance in conditional event D1. For example, a range of time in which the execution timing provided by the AI/ML model is permitted is configured for the measured time in conditional event T1. In the second condition, when conditional event D1 or conditional event T1 is used, a range in which the conditional handover is forcibly executed may be configured for each of the thresholds.

### Second Embodiment

A second embodiment will be described. In the second embodiment, differences from the first embodiment will mainly be described.

As described in the first embodiment, when the UE 100 is involved in the determination for the conditional handover, the network may need to collect information indicating whether a handover failure due to the conditional handover is caused by the determination in the UE 100 or by the network indication. In the second embodiment, description will be given of an example in which the UE 100 transmits, to the gNB 200 as log information, whether the failure is due to the determination in the UE 100 or the indication from the network.

Specifically, first, the user equipment transmits, to the base station, log information including an execution result of the conditional handover and execution trigger information indicating that the conditional handover has been executed using an AI/ML model or that the conditional handover has been executed using a network configuration without using the AI/ML model.

Such information collection enables the network to perform area optimization and enables the UE 100 to optimize inference model control. Such optimization also enables, for example, the UE 100 to appropriately execute wireless communication using the AI/ML model.

### (2.1) MDT

Here, MDT used in the second embodiment will be described.

An operator may conduct a drive test to measure a radio situation in a coverage area. Information collection through the drive test allows optimization of configurations of the base station and of antenna tilt in the base station. However, the drive test conducted by the operator may require a high man-hour and a high cost. Thus, the 3GPP is studying an approach to cause the UE 100 to measure and report the information collected in the drive test. This enables a reduction in Operating Expense (OPEX). For example, Minimization of Drive Test (MDT) is a generic term for techniques used to minimize the execution of the drive test.

The MDT defines two schemes, i.e., Immediate MDT and Logged MDT, for acquisition and reporting of measured information in the UE 100. The immediate MDT is a scheme in which the UE 100 in the RRC connected state acquires and reports measured information. In the immediate MDT, processing is performed based on an RRC configuration related to measurement (MeasurementConfiguration) and a reporting procedure. On the other hand, the logged MDT is a scheme in which the UE 100 in the RRC idle state or the RRC inactive state acquires and reports measured information. In the log MDT, the UE 100 records (logs) a measurement result, that is, the UE 100 does not immediately report the measurement result to the gNB 200, but after acquiring the measurement result, reports the measurement result to the gNB 200 in response to a request from the gNB 200. In the logged MDT, the UE 100 performs processing based on the RRC configuration (LoggedMeasurementConfiguration).

### (2.2) Operation Example According to Second Embodiment

An operation example according to the second embodiment will be described.

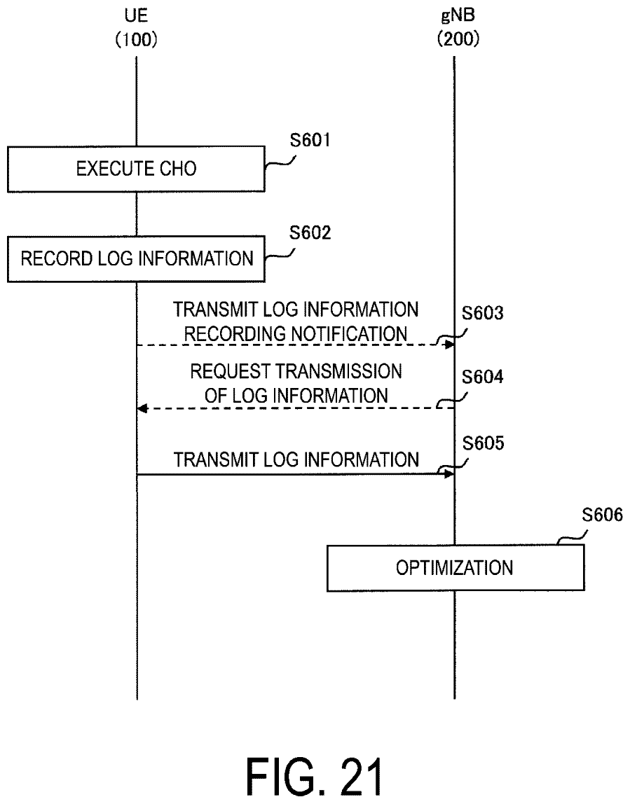

FIG. 21 is a diagram illustrating the operation example according to the second embodiment. Note that the UE 100 has been configured with the MDT from the gNB 200.

In step S601, the UE 100 performs a conditional handover and starts accessing the target cell.

In step S602, in response to the completion of execution of the conditional handover, the UE 100 records log information. The log information may be any of the following information.

(Y1) Execution result of the conditional handover: Specifically, for example, the information indicates one of the conditional handover having succeeded or having failed.

(Y2) Trigger of the conditional handover: Specifically, for example, the information may indicate one of inference by the AI/ML model having been used as an execution trigger of the conditional handover or a network configuration having been used as an execution trigger of the conditional handover. Alternatively, for example, the information may indicate that the conditional handover has been executed using the AI/ML model or that the conditional handover has been executed using the network configuration without using the AI/ML model. The information indicating the trigger of the conditional handover may be referred to as “execution trigger information”.

(Y3) Identification information of the AI/ML model used in the UE 100: The identification information may be, for example, a model ID of the AI/ML model. Alternatively, the identification information may be represented by a model attribute of the AI/ML model (for example, one of a proprietary model or an open format model).

(Y4) Current radio information: For example, the radio quality of a source cell and the target cell.

(Y5) A time stamp, position information indicating the position of the UE 100, or the like.

In step S603, the UE 100 may notify the gNB 200 that the UE has log information recorded therein. The UE 100 may transmit the notification using an RRC message, a MAC CE, or the like.

In step S604, the gNB 200 may request the UE 100 to transmit the log information to the gNB 200. The gNB 200 may make the request using an RRC message, a MAC Control Element (CE), or DCI.

In step S605, the UE 100 transmits the log information to the gNB 200. The UE 100 may transmit the log information by utilizing a measurement report. For example, the UE 100 may transmit the log information by utilizing another RRC message.

In step S606, the gNB 200 uses the received log information to perform area optimization or optimizes the AI/ML model control in UE 100.

### (2.3) Another Example According to Second Embodiment

In the example described in the second embodiment, the UE 100 performs the conditional handover. However, the present disclosure is not limited thereto. For example, even when the UE 100 performs the legacy handover, the second embodiment can be implemented. In this case, the second embodiment can be implemented by replacing “execution of the conditional handover” in step S601 with “execution of the legacy handover”. The UE 100 may infer the execution timing of the legacy handover using the AI/ML model. The input (inference data) to the AI/ML model is the same as that in the first embodiment. The second embodiment can be implemented by replacing “(Y1) execution result of the conditional handover” with “execution result of the legacy handover”.

In other words, the user equipment (for example, the UE 100) transmits, to the base station (for example, the gNB 200), the log information including the execution result of the handover and the execution trigger information indicating one of the handover having been performed using the AI/ML model or the handover having been performed using the network configuration without using the AI/ML model.

Accordingly, even in the case of the legacy handover, the network can perform area optimization, optimization of inference model control in the UE 100, and the like based on the log information. Such optimizations also enable, for example, the UE 100 to appropriately execute wireless communication using the AI/ML model.

### Other Embodiments

In the first embodiment described above, the supervised learning has mainly been described. However, the present disclosure is not limited thereto. For example, the first embodiment may be applied to the unsupervised learning or the reinforcement learning.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station. The network node may include a combination of at least a part of the apparatus of the core network and at least a part of the base station.

A program (e.g., information processing program) for causing a computer to execute each process or each function according to the above-described embodiment may be provided. A program (e.g., mobile communication program) may be provided that causes the mobile communication system 1 to execute each of the processing operations or each of the functions according to the embodiments described above. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions realized by the UE 100 or the gNB 200 (network node) may be implemented in circuitry or processing circuitry including general-purpose processors, special-purpose processors, integrated circuits, Application Specific Integrated Circuits (ASICs), Central Processing Units (CPUs), conventional circuits, and/or combinations thereof which are programmed to perform the described functionality. The processor may include transistors or any other circuits and may be considered to be circuitry or processing circuitry. The processor may be a programmed processor that executes a program stored in the memory. As used herein, circuitry, a unit, means is hardware programmed to achieve, or hardware executing, the described functionality. The hardware may be any hardware disclosed herein or any hardware programmed to achieve or known to execute the described functionality. When the hardware is a processor that is considered to be a type of circuitry, the circuitry, means, or unit is a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on.” The phrase “depending on” means both “only depending on” and “at least partially depending on.” The terms “include,” “comprise” and variations thereof do not mean “include only items stated” but instead mean “may include only items stated” or “may include not only the items stated but also other items.” The term “or” used in the present disclosure is not intended to be “exclusive or.” Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure. It is also possible to combine each embodiment, each operation example, each process, and the like without contradicting.

### Supplements

### Supplementary Note 1

A communication control method in a mobile communication system, the communication control method including:
configuring, by a network node, a predetermined range of radio quality for a user equipment, wherein the predetermined range of radio quality represents a range of radio quality in which the user equipment is permitted to determine an execution timing of a conditional handover by using an AI/ML model.

### Supplementary Note 2

The communication control method according to Supplementary Note 1, wherein
the configuring includes configuring, by the network node, the user equipment with a threshold of radio quality at which the user equipment is caused to perform the conditional handover without using the AI/ML model.

### Supplementary Note 3

The communication control method according to Supplementary Note 1 or 2, wherein the configuring includes configuring the user equipment with a first condition of the conditional handover including the predetermined range of radio quality and a second condition of the conditional handover including the threshold of radio quality, and
the communication control method further includes:
executing, by the user equipment, the conditional handover at the execution timing inferred using the AI/ML model when the radio quality satisfies the first condition; and
executing, by the user equipment, the conditional handover without using the AI/ML model when the AI/ML model fails to appropriately infer the execution timing and the radio quality satisfies the second condition.

### Supplementary Note 4

The communication control method according to any one of Supplementary Notes 1 to 3, further including:
transmitting, by the user equipment to the network node, log information including an execution result of the conditional handover and execution trigger information indicating one of the conditional handover having been executed using the AI/ML model or the conditional handover having been executed using a network configuration without using the AI/ML model.

### Supplementary Note 5

A communication control method in a mobile communication system, the communication control method including:
transmitting, by a user equipment to a network node, log information including an execution result of a handover and execution trigger information indicating one of the handover having been executed using an AI/ML model or the handover having been executed using a network configuration without using the AI/ML model.

### REFERENCE SIGNS

1: Mobile communication system
20: 5GC (CN)
100: UE
110: Receiver
120: Transmitter
130: Controller
200: gNB
210: Transmitter
220: Receiver
230: Controller
A1: Data collector
A2: Model trainer
A3: Model inferrer
A4: Data processor
TE: Transmission entity
RE: Reception entity

1. A communication control method in a mobile communication system, the communication control method comprising:
configuring, by a network node, a predetermined range of radio quality for a user equipment,
wherein the predetermined range of radio quality represents a range of radio quality in which the user equipment is permitted to determine an execution timing of a conditional handover by using an Artificial Intelligence (AI)/Machine Learning (ML) model.

2. The communication control method according to claim 1, wherein
the configuring comprises configuring, by the network node, the user equipment with a threshold of radio quality at which the user equipment is caused to perform the conditional handover without using the AI/ML model.

3. The communication control method according to claim 2, wherein
the configuring comprises configuring the user equipment with a first condition of the conditional handover comprising the predetermined range of radio quality and a second condition of the conditional handover comprising the threshold of radio quality, and
the communication control method further comprises:
executing, by the user equipment, the conditional handover at the execution timing inferred using the AI/ML model, when the radio quality satisfies the first condition; and
executing, by the user equipment, the conditional handover without using the AI/ML, model when the AI/ML model fails to appropriately infer the execution timing and the radio quality satisfies the second condition.

4. The communication control method according to claim 1, further comprising:
transmitting, by the user equipment to the network node, log information comprising an execution result of the conditional handover and execution trigger information indicating one of the conditional handover having been executed using the AI/ML model or the conditional handover having been executed using a network configuration without using the AI/ML model.

5. A communication control method in a mobile communication system, the communication control method comprising:
transmitting, by a user equipment to a network node, log information comprising an execution result of a handover and execution trigger information indicating one of the handover having been executed using an AI/ML model or the handover having been executed using a network configuration without using the AI/ML model.

6. A network node in a mobile communication system, comprising:
a controller configured to perform the communication control method according to claim 1.

7. A user equipment in a mobile communication system, the user equipment comprising:
a receiver configured to receive, from a network node, information comprising a predetermined range of radio quality,
wherein the predetermined range of radio quality represents a range of radio quality in which the user equipment is permitted to determine an execution timing of a conditional handover by using an Artificial Intelligence (AI)/Machine Learning (ML) model.
